(19) United States
(12) Patent Application Publication
(10) Pub. No.: US 2014/0204344 A1
(43) Pub. Date: Jul. 24, 2014

(54) DS Digi Holo Wheels

(71) Applicant: Derek S. Harris, Roslyn, PA (US)

(72) Inventor: Derek S. Harris, Roslyn, PA (US)

(21) Appl. No.: 14/101,057

(22) Filed: Dec. 9, 2013

Related U.S. Application Data
(60) Provisional application No. 61/734,768, filed on Dec. 7, 2012.

(51) Int. Cl. G03H 1/00; G03H 1/26

(52) U.S. Cl. CPC G03H 1/0005; G03H 1/268
USPC 353/13; 359/23

(57) ABSTRACT

The invention a set of tire rims comprising light assemblies which project holographic images. When installed, Harris Wheels project a designated image such as a decorative pattern, logo, or cartoon animation onto the face of the rim, providing the illusion that the image is moving as the rim spins. The present invention provides auto enthusiasts a unique means of customizing their cars while also increasing visibility of the vehicle at night.

### CLAIM OF PRIORITY

This patent application claims priority under 35 USC 119 (e) (1) from U.S. Provisional Patent Application Ser. No. 61/734,768 filed Dec. 7, 2012, herewith entitled, “Harris' Wheels/DS Digi Holo Wheels” by inventor Derek Harris.

### FIELD OF THE INVENTION

The present invention pertains to the field of vehicle accessories, and more specifically to the field of vehicle wheel rims.

### BACKGROUND OF THE INVENTION

The prior art has put forth several designs for vehicle wheel rims. Among these are:

U.S. Pat. No. 4,878,719 to John E. Wreede, James E. Scott and Richard B. Upper describes a vehicle wheel cover with a reflection type hologram assembly having multiple exposure images therein. The sun or an artificial light source illuminates the hologram assembly as it rotates as a result of the vehicle moving. The exposure images are successively reconstructed to produce a single image that may be remotely positioned from and stationary relative to the rotating wheel cover.

U.S. Pat. No. 6,637,829 to Vernon Jenkins describes an improved wheel wherein decorative items such as gem stones are embedded in either the wheel surface, a special mounting section attached to the wheel surface, or to a spoke strap that wraps around each spoke and positions embedded gem stones on the outside surface of the spoke. The improvement and related devices are symmetrically attached for positional correspondence of the decorative items among the spokes. Spokes or spoke like features of wheel covers are similarly improved.

U.S. Pat. No. 7,524,093 to Ronald Sinnette and Patrick Massie describes a customized non rotatable decorative displaying image mechanism wheel assembly. The wheel assembly comprises a wheel mount supportable by the wheel of a vehicle. A protective cover is affixed to the wheel mount to form a housing with an interior cavity therein. The display holder is transparent or translucent with any image, logo, emblem, insignia or hologram covering affixed thereto. A display holder and member are positioned behind the protective covering within the cavity of the housing. The display holder is bolted with predefined weighted members and ball bearings such that the display holder and member remain stationary during within the interior cavity as the vehicle's wheel turns. The display member can be illuminated by a light source which is powered by an electromechanical power source.

None of these prior art references describe the present invention.

### SUMMARY OF THE INVENTION

It is an object of the present invention to provide a unique means of customizing vehicle wheels while increasing vehicular visibility at night.

### BRIEF DESCRIPTION OF THE DRAWINGS

FIG. 1 is an illustrative prototypical view showing a vehicle with skull and fire holographic images projected on wheel rims.

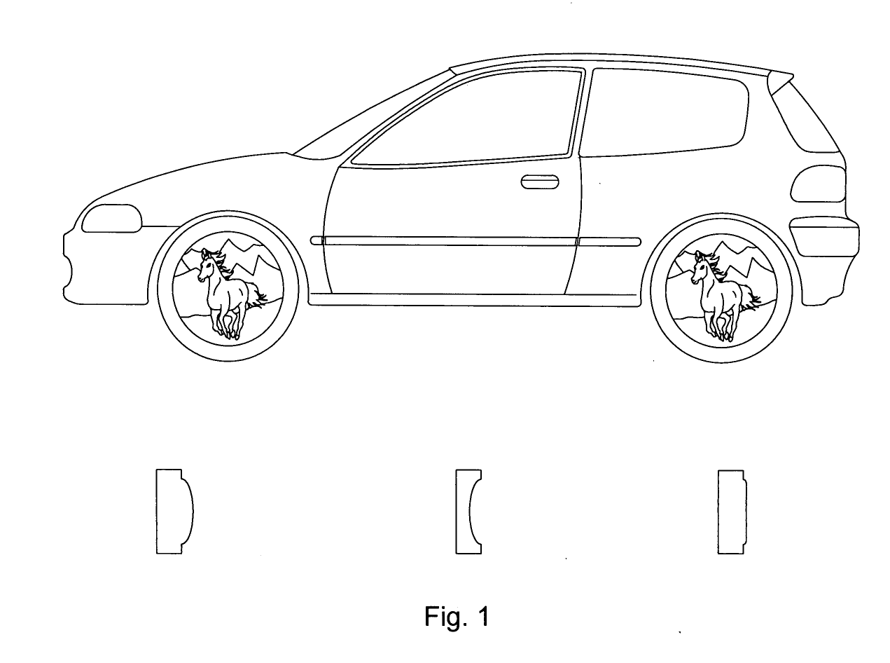

FIG. 2 is an illustrative and functional display showing a convex hologram style, a concave hologram style, a flat hologram style, and a customizable display hologram that work like a TV projection screen.

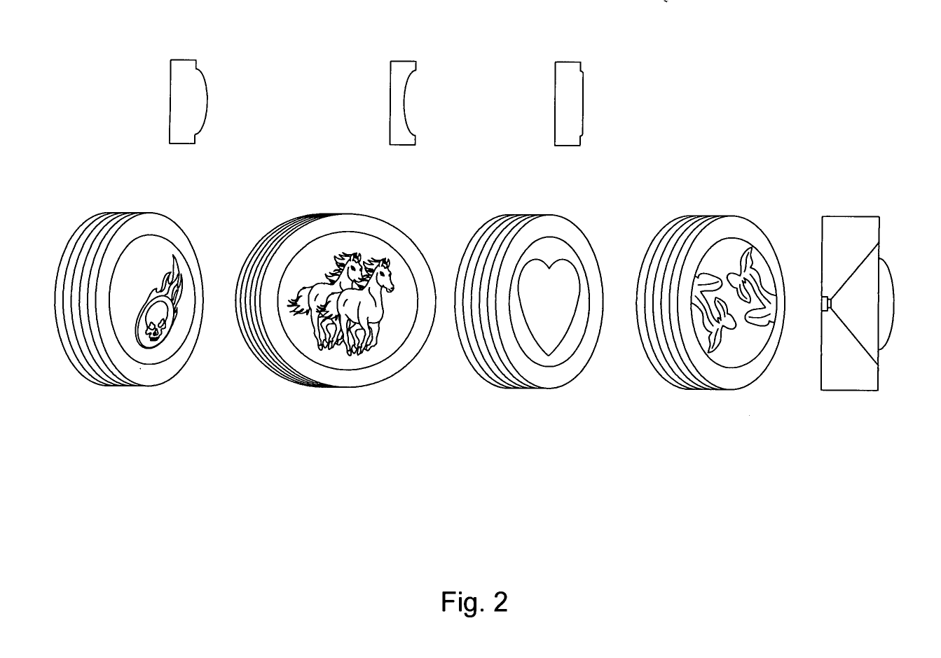

FIG. 3 is an illustrative partially exploded front view showing the clear cover, screen image and special car rim.

FIG. 4 is an illustrative front view showing the clear cover, screen image and special car rim.

FIG. 5 is an illustrative exploded front view showing the clear cover, screen image and special car rim and standard car tire.

### DETAILED DESCRIPTION OF THE INVENTION

While detail work of a fresh wash and wax, polished tires and shiny chrome rims make any car look nice, many auto enthusiasts prefer a more distinct approach such as personalizing their vehicle to express their individuality and interests. Whether ordering personalized license plates, attaching fancy mud flaps to the rear tires or airbrushing elaborate designs upon a car's hood and trunk, customizing one's vehicle is truly an exciting and artistic form of self expression. People often customize their vehicle by installing floating neon lights beneath their vehicle's undercarriage. Incorporating decorative lighting illuminates a vehicle in a sleek and unique fashion and provides many car owners with a stylish way to revamp the overall appearance of their vehicle. Installing a new set of tires is another customization used to revamp the overall appearance of cars, trucks and vans. Produced in a variety of styles such as mag wheels, low profile, whitewashed and modular, a new set of tires vastly improves an automobile's appearance. Although most car enthusiasts agree that the appropriate tires are a crucial element to the overall design of their automobile, they also know that a set of high polished rims add the perfect finishing touch. Rims are manufactured in a wide variety of styles and materials such as shiny chrome, gold plated or polished aluminum.

The present invention, hereinafter referred to as Harris' Wheels or DS Digi Holo Wheels, is a set of tire rims comprising light assemblies which project holographic images. When installed, Harris Wheels project a designated image such as a decorative pattern, logo, or cartoon animation onto the face of the rim, providing the illusion that the image is moving as the rim spins. The present invention provides auto enthusiasts a unique means of customizing their cars while also increasing visibility of the vehicle at night. Manufactured with a projection screen material such as plasma, liquid crystal display or LCD, or cathode ray tube or CRT, the DS Digi Holo Wheel is shaped as a convex, concaved, or flat screen. The screen coverings are manufactured in sizes appropriate for various styles and sizes of popular tires. The standard size is approximately twenty two inches. The DS Digi Holo Wheels rims are packaged in sets of four rims.

Light assemblies are incorporated into the well of each Harris Wheel and are utilized to project holographic images which are three dimensional or 3D images projected as to appear to be floating in space. An elegant imaging medium, a holographic display relays an image in full color movement. The three types of holograms are single image, multi channel and stereogram. A single image hologram is where a subject sits still and looks 3D and is used for documentary or portrait holography. A multi channel hologram displays a few different images that usually change from side to side. Showing a smooth movement of sequential action, a stereogram contains a few hundred frames similar to cartoon movie animation and is computer generated from digital video or movie tape. DS Digi Holo Wheels utilize a multi channel or stereogram technology that include projections of animated characters, catchphrases, words, names or fancy patterns and designs such as a laughing skull, flying butterflies, runaway horses, a surfing dog, children characters, and video game characters like Pac Man. The animated images are moving with the movement of the displays carried from the front rims to the rear. The motion of the image is activated as the wheels of the vehicle move and stops when the vehicle is stopped or parked. Power is supplied to the DS Digi Holo Wheels by an external rechargeable battery pack or the vehicle's battery. The light assemblies and design choices are activated by a touch screen controller located on or connected to the vehicle's radio system. As an option, this controller is sized to attach to one's key chain or key fob. This controller comprises standard automobile commands such as lock, unlock, trunk control. In addition, an alarm mode is integrated into this system along with GPS and a location mode for easily locating one's vehicle in a crowded parking lot. An additional embodiment of the present invention is to incorporate Harris Wheels into the vehicle's speaker system so that a digital music reaction display hologram can react and move in tune with the beat of the music being played.

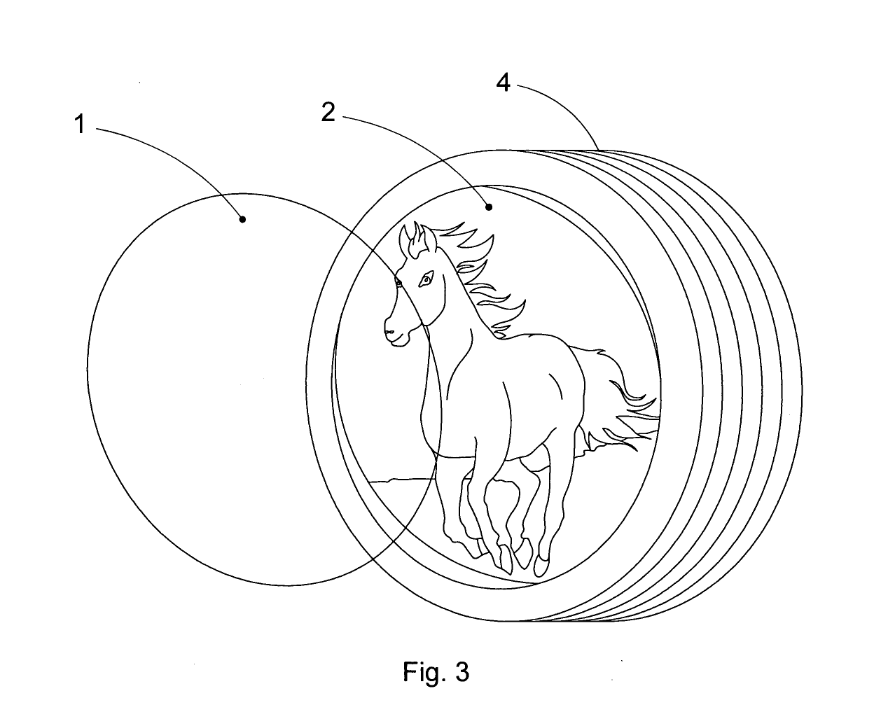

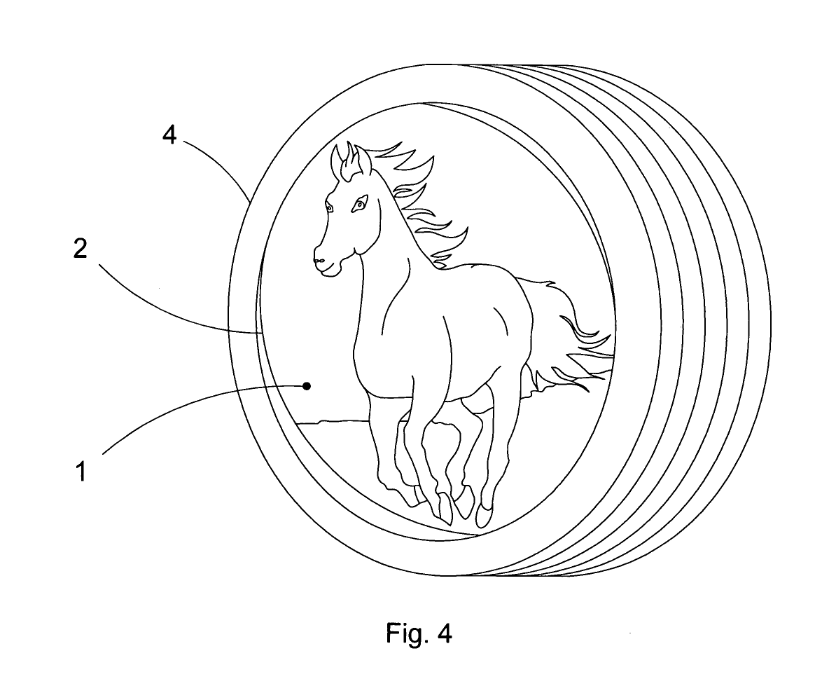

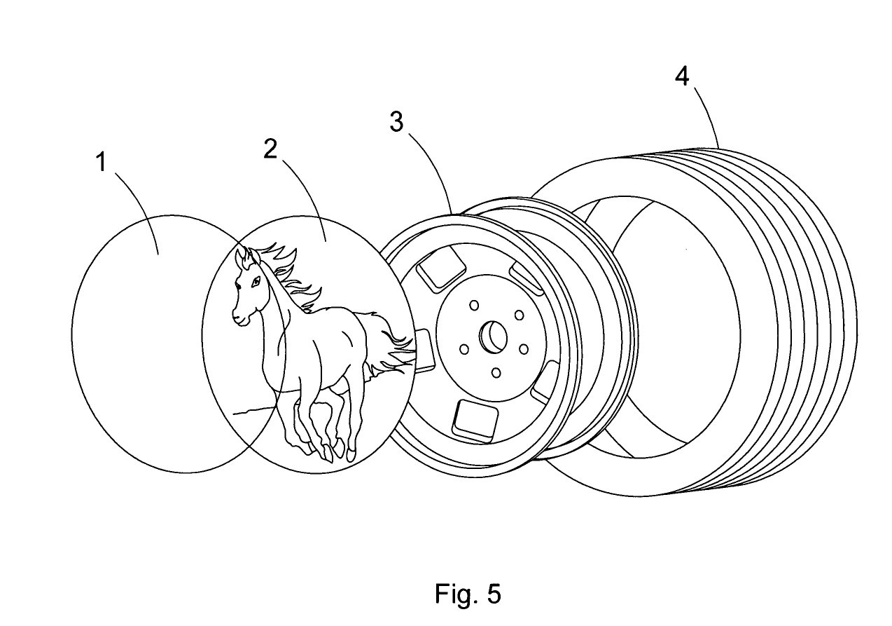

FIGS. 3, 4 and 5 show the device wherein 1 is the clear plastic or glass cover that can withstand any road condition. Element 2 is the digital screen, holographic screen or image, or picture image for a hub cap with or without LED lights on the back. Element 3 is a specially designed car rim for containing the digital or holographic screens, or regular screen for a hub cap picture image. Element 4 is a standard car tire.

Following are descriptions of additional alternative embodiments. Party Face Cam Mode: a user can take picture of face using an in-vehicle cam or cell phone and is able to distort or color picture, if desired. Then the user can down load the face of one or more passengers that are in the vehicle. Four wheels create any desired combinations. Any picture can be used, but one purpose is to make it look like they are in the Digi Holo Wheel.

Glow Wheels Mode:

For a digital version, the glow is produced by a digital, LED, or other lighting source; and for the hologram version the glow is produced by LED or other lighting source; the lit picture insert version will have LED or other lighting source; the unlit picture version or lighting can be added behind picture or any picture can be made to fit wheels that will glow with sun light charge. The picture can have some parts that glow or the whole thing can glow or a different image by day and glows a different image by night.

Digital Reflection Mode:

Using a camera in the Digi Holo Wheels to either reflect what is in the camera view like a digital mirror. A switch to mode to show what is on the opposite side can be used. This mode has no sun glare thereby producing a clean reflection.

Digital Reaction Mode:

By adding a sensor to the Digi Holo Wheel the animations react to cars, people, or other things. For example, eyes looking at people, characters reacting to people or even when a car passes, spikes come out or the Digi Holo Wheel transforms to buzz saws. Any possibility is to have characters react to motion, such as waving, barking dogs, sniff.

Digi Holo Wheel Sensors:

The Digital plus version contains sensors for temperature, mileage, gas, fluids, time or may just connect with car computer sensor. Can be viewed from wheel instead of being in car or even having the car on.

Touch Screen Mode:

Much like touch screens on computers, i-pads, Smart phones and Smart TVs. Touch screen technology enables the user to have a menu screen and have touch or a stylus pen type to affect picture or menu. This feature can also lock and control the other wheels.

Electric Ball Wheel App:

When wheel is touched electricity goes to places touched.

Weather Changing Wheel:

With the sensor and touch screen, wheel can change the color or picture with the weather or touch to react to touch, heat, bumps in the road, pot holes, and hills. This mode can be turned on and off.

Fireworks Mode:

For digital version. Fireworks on your Digi Holo Wheels will make night time driving a blast.

The Digi Holo Wheels should be as visually great in the day as well as at night.

Use of the Harris Wheels/DS Digi Holo Wheels is simple and straight forward. First, the consumer selects which set of coverings best suit their vehicle model along with their image preference. An owner of a Ford Mustang may select rims which project the image of galloping horses as a show of pride in their vehicle. A free spirited coed may select a projected flight of butterflies as a fanciful adornment to a Volkswagen Beetle. The consumer then has a mechanic or service technician professionally install the Harris Wheels or skilled auto owners may install the coverings themselves. Once installed, a user activates the Harris' Wheels/DS Digi Holo Wheels by simply turning on their vehicle ignition and shifting to Drive to enjoy the dazzling projected holographic display.

Along with self expression and aesthetic attributes, Harris' Wheels or DS Digi Holo Wheels provide a practical purpose. The brilliant illumination emanating from the tires render the vehicle highly visible at night and significantly increase driver safety. Easily operated, the present invention creates a dazzling holographic display that instantly transforms the appearance of any car, truck or motorcycle. Reasonably priced, Harris Wheels are well received by auto enthusiasts.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A wheel customization device for increasing vehicular visibility at night, comprising a holographic projection system sized to fit in a wheel rim for an automobile.

2. The wheel customization device of claim 1 wherein the holographic projection system is capable of projecting a moving holographic image.

3. The wheel customization device of claim 2 wherein the moving holographic image moves when the wheel of the automobile is moving and stops when the wheel automobile is stopped.

4. The wheel customization device of claim 2 wherein the moving holographic image moves to accompany music.

5. The wheel customization device of claim 2 wherein the device utilizes a multi channel or stereogram technology to provide movement of the image.

6. The wheel customization device of claim 1 wherein the device utilizes a single channel technology to provide a stationary image.

7. A wheel customization device for increasing vehicular visibility at night, comprising a digital projection system sized to fit in a wheel rim for an automobile.

8. The device of claim 1 wherein the device comprises a clear plastic or glass cover, a screen for projection of an image, a rim for containing the screen and the cover.

9. The device of claim 7 wherein the device comprises a clear plastic or glass cover, a screen for projection of an image, a rim for containing the screen and the cover.
